(19) United States
(12) Patent Application Publication
(10) Pub. No.: US 2019/0089750 A1
(43) Pub. Date: Mar. 21, 2019

(54) Trunk Routing using a Service Parameter

(71) Applicant: Microsoft Technology Licensing, LLC, Redmond, WA (US)

(72) Inventors: Amer Aref HASSAN, Kirkland, WA (US); Danny LEVIN, Tel Aviv (IL); David Anthony LICKORISH, Sammamish, WA (US); Gareth Lyndon Eadred BRIDGES, Redmond, WA (US); Russell Andrew PENAR, Highlands Ranch, CO (US)

(73) Assignee: Microsoft Technology Licensing, LLC, Redmond, WA (US)

(21) Appl. No.: 15/705,763

(22) Filed: Sep. 15, 2017

(51) Int. Cl. H04L 29/06; H04L 12/709

(52) U.S. Cl. CPC H04L 65/1069; H04L 65/1006; H04L 45/245

(57) ABSTRACT

Techniques for trunk routing using a service parameter are described. Generally, techniques described herein enable a service parameter for a communication session to be used to select a suitable communication trunk (e.g., a Session Initiation Protocol (SIP) trunk) for routing the communication session. In one example, a database of communication trunks is queried to identify a communication trunk that meets a service parameter for a communication session. In an additional or alternative implementation, a negotiation process can be employed to select a suitable communication trunk for routing a communication session.

### BACKGROUND

Today's networked environment provides a tremendous array of options for routing communications. One particular technique, Session Initiation Protocol (SIP) trunking, offers an economical way of providing communication paths between different networks. SIP trunking, for instance, can be used to connect communications via Internet-based telephony across different data networks. Current implementations for SIP trunking, however, are complex and typically require front-end sorting from a calling device to identify a suitable trunk for routing a call.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for trunk routing using a service parameter are described. Generally, techniques described herein enable a service parameter for a communication session to be used to select a suitable communication trunk (e.g., a Session Initiation Protocol (SIP) trunk) for routing the communication session. In one example, a database of communication trunks is queried to identify a communication trunk that meets a service parameter for a communication session. In an additional or alternative implementation, a negotiation process can be employed to select a suitable communication trunk for routing a communication session.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 depicts an example data table that tracks information for service providers and communication trunks in accordance with one or more implementations.

FIG. 3 depicts an example implementation scenario for selecting a communication trunk for routing a communication session in accordance with one or more implementations.

FIG. 4 depicts an example implementation scenario for dynamic negotiation of a trunk for routing a communication session in accordance with one or more implementations.

FIG. 5 is a flow diagram that describes steps in a method for generating a profile database for different communication trunks in accordance with one or more implementations.

FIG. 6 is a flow diagram that describes steps in a method for establishing a communication session over a communication trunk in accordance with one or more implementations.

FIG. 7 is a flow diagram that describes steps in a method for causing a communication session to be routed over a communication trunk in accordance with one or more implementations.

FIG. 8 is a flow diagram that describes steps in a method for negotiating with service providers to identify a suitable communication trunk for routing a communication session in accordance with one or more implementations.

FIG. 9 illustrates an example system and computing device as described with reference to FIG. 1, which are configured to implement implementations of techniques described herein.

### DETAILED DESCRIPTION

Techniques for trunk routing using a service parameter are described. Generally, techniques described herein enable service parameters for a communication session to be used to select a suitable communication trunk (e.g., a Session Initiation Protocol (SIP) trunk) for routing the communication session. For instance, a call request for connecting a communication session includes a service parameter for the communication session. The service parameter, for example, includes an attribute of the communication session and/or a requested capability of a communication trunk to be used for routing the communication session. Examples of different service parameters are described below. The service parameter is used to identify a communication trunk and/or a service provider that is capable of routing the communication session according to the service parameter.

In one example, a database of communication trunks is maintained that correlates different instances of communication trunks with trunk profiles that describe service capabilities of the respective trunks. The database can be queried with a service requirement for a communication session to identify a communication trunk with a service capability suitable for handling the service requirement. The communication session is then routed over the communication trunk.

In an additional or alternative implementation, a negotiation process can be employed to select a suitable communication trunk for routing a communication session. For instance, service providers that implement different communication trunks are queried with a service parameter for a communication session. A service provider that returns a query response indicating that the service provider maintains a communication trunk capable of meeting the service parameter is selected to connect the communication session. In at least one implementation, a negotiation process can be performed with a service provider or set of service providers that are first identified from the database described above.

Accordingly, techniques described herein provide end-to-end performance improvements for network communications. For instance, by selecting a communication trunk that is capable of handling a service parameter for a communication session, device and network performance is improved by avoiding other communication trunks that may not be capable of supporting the service parameter. This can avoid performance errors, such as a dropped call and/or excessive packet errors that may occur if a communication trunk that does not support a service parameter is used for session routing. Further, device and network performance is improved by not requiring a client device and/or a local network that initiates a call to engage in a trunk selection process that would utilize various device and network resources, such as data processing, memory, and network bandwidth resources.

In the following discussion, an example environment is first described that is operable to employ techniques described herein. Next, some example scenarios are described for trunk routing using a service parameter in accordance with one or more implementations. Following this, some example procedures are described in accordance with one or more implementations. Finally, an example system and device are described that are operable to employ techniques discussed herein in accordance with one or more implementations.

Having presented an overview of example implementations in accordance with one or more implementations, consider now an example environment in which example implementations may by employed.

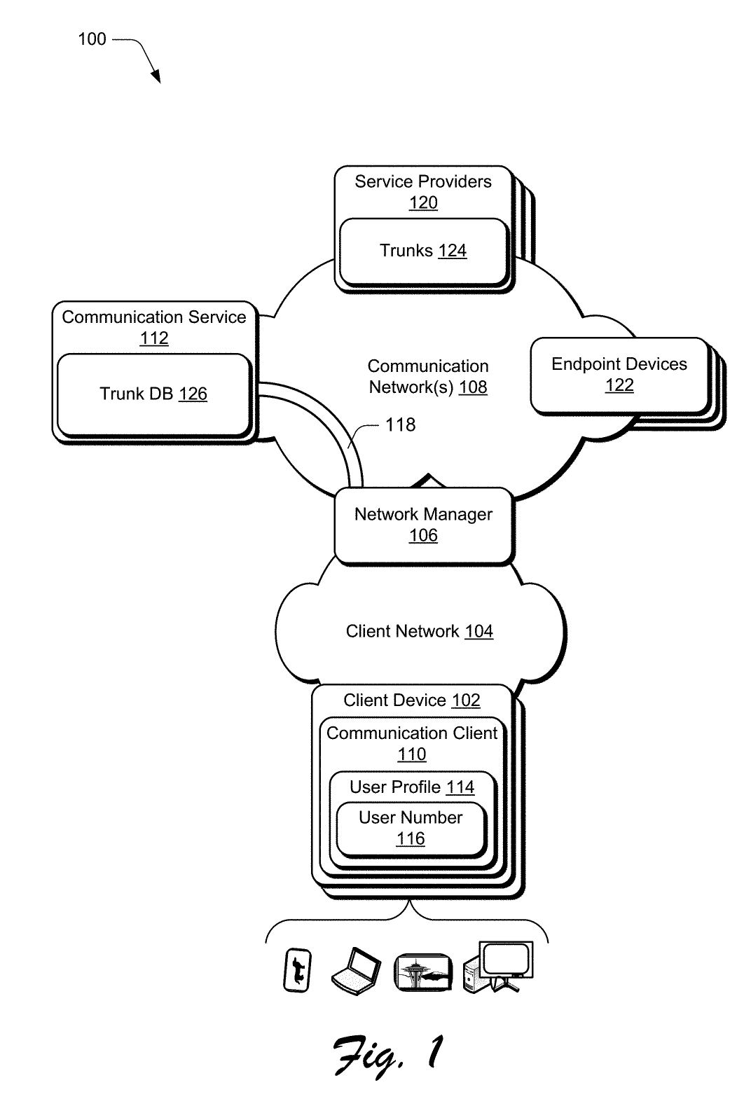

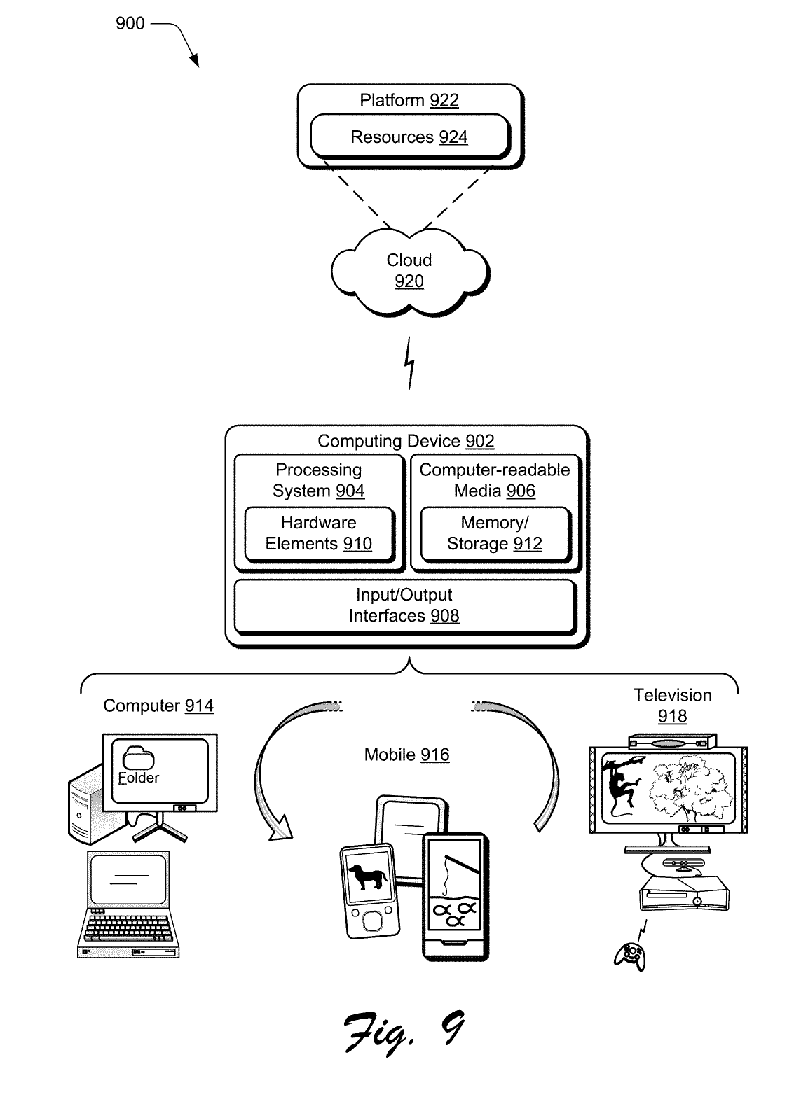

FIG. 1 is an illustration of an environment 100 in an example implementation that is operable to employ techniques for trunk routing using a service parameter described herein. The environment 100 includes a client device 102 connected to a client network 104. The client device 102 is representative of an instance of a number of different devices that are connectable to the client network 104 and that are configured to communicate via the client network 104. The client device 102 may be configured in a variety of ways, such as a wireless cellular phone (e.g., a smartphone), a tablet, a laptop, and so forth. One example implementation of the client device 102 is presented below as the computing device 902 of FIG. 9.

The client network 104 generally represents a local network for an entity such as an enterprise entity, a government entity, and educational entity, and so forth. The client network 104 includes a network manager module (“network manager”) 106, which is representative of functionality for performing various connectivity-related tasks for the client network 104. The network manager 106, for instance, enables connectivity between the client network 104 and a communication network 108. Generally, the communication network 108 is representative of different connected components that exchange, process, and/or route data to enable different forms of communication. Examples of the communication network 108 include a wide area network (WAN) (e.g., the Internet), a wireless cellular communication network, a Public Switched Telephone Network (PSTN), and combinations thereof. The communication network 108, for instance, represents a combination of interconnected wireless and wired networks that enable communication at various geographic locations and via a variety of different communication modalities.

The client device 102 includes a communication client 110, which is representative of functionality to enable different forms of communication via the client device 102. Examples of the communication client 110 include a voice communication application (e.g., a Voice over Internet Protocol (VoIP) client), a video communication application, a messaging application, a content sharing application, and combinations thereof. The communication client 110, for instance, enables different communication modalities to be combined to provide diverse communication scenarios. In at least some implementations, the communication client 110 represents an application that is installed on the client device 102. Additionally or alternatively, the communication client 110 can be implemented all or in part as a remote application, such as accessed via a web browser, a web application, and so forth.

According to various implementations, the communication client 110 is configured to enable various types of communication via interaction with a communication service 112. The communication service 112 is representative of a service to perform various tasks for management of communication between the client device 102 and other entities, e.g., other client devices. The communication service 112, for instance, can manage initiation, moderation, and termination of communication sessions for the client device 102. Examples of the communication service 112 include a VoIP service, an online conferencing service, a unified communications and collaboration (UC&C) service, and so forth. In at least some implementations, the communication service 112 may be implemented as and/or be connected to a private branch exchange (PBX) in communication with a Public Switched Telephone Network (“PSTN”) to enable voice communication between the client device 102 and other devices and/or services.

The communication client 110 is associated with a user profile 114, which represents a way of authenticating a particular user with the communication client 110 and the communication service 112, and for tracking user-specific authentication information (e.g., username, password, and so forth), user settings, contacts, and other data for the user. In at least some implementations, the user profile 114 is portable such that the user can authenticate with a different instance of the communication client 110, and make calls via the different instance of the communication client 110 that are identified as being connected with the user profile 114. The user profile 114 includes a user number 116, which generally represents a telephone number that can be used to place and receive calls via the client device 102. In at least one implementation, the user number 116 is assigned and managed by the communication service 112.

Further to techniques for trunk routing using a service parameter described herein, the network manager 106 is connected to the communication service 112 via an integrated trunk 118. Generally, the integrated trunk 118 represents a SIP trunk that can be leveraged to route a variety of different types of communication between the client network 104 and the communication service 112. In at least some implementations, the integrated trunk 118 is type agnostic such that different types of communication sessions can be routed across the integrated trunk 118, regardless of the type of communication session or a service parameter for the communication session. While a single integrated trunk 118 is illustrated, the integrated trunk 118 may be implemented as a logical representation of multiple different physical instances of SIP trunks that connect the client network 104 to the communication service 112.

The environment 100 further includes service providers 120 and endpoint devices 122. The service providers 120 are representative of functionality for enabling connectivity for communication across the communication network 108. The service providers 120, for instance, are representative of hardware and logic infrastructure for routing communications between the client network 104 and the endpoint devices 122. Examples of the service providers 120 include wireless cellular carriers, broadband data network providers, PSTN providers, and so forth.

The endpoint devices 122 are representative of different devices with which the client device 102 may exchange communication media. In at least one implementation, the endpoint devices 122 represent end-user devices, such as a wireless cellular phone, a PSTN phone, a communication-enabled computing device, and so forth.

As part of enabling communication media to be exchanged between the client device 102 and the endpoint devices 122, the service providers 120 maintain SIP trunks (“trunks”) 124, which are representative of collections of different connectivity paths across the communication network 108. Generally, each service provider 120 maintains its own set of trunks 124 that can be used to route communication media. As further described below, the trunks 124 can be categorized based on their respective capabilities, such as types of media and types of communication sessions that the trunks are designated to handle. For instance, based on their different physical and/or logical configurations, instances of the trunks 124 may differ from one another in terms of their respective routing capabilities. Thus, based on a characteristic of a particular communication session, a suitable service provider 120 and corresponding trunk 124 can be selected for handling the communication session. In at least one implementation, the network manager 106 represents a SIP proxy server that can be leveraged to enable SIP-based communication sessions to be established between the client device 102 and an endpoint device 122 across one or more of the trunks 124.

To enable a suitable service provider 120 and trunk 124 to be selected for routing a communication session, the communication service 112 maintains a trunk database (“DB”) 126. Generally, the trunk DB 126 identifies the different service providers 120 and specifies for each service provider 120 the types of trunks 124 that the service provider 120 maintains. In at least some implementations, the trunk DB 126 identifies a preferred service provider 120 and/or trunk 124 for a particular type of communication session and/or communication media type. For instance, a call request from the client device 102 that is communicated to the communication service 112 over the integrated trunk 118 can be used to identify a suitable service provider 120 and/or trunk 124 for connecting a call to an endpoint device 122 based on the call request.

Having described an example environment in which the techniques described herein may operate, consider now some example implementation details and scenarios for trunk routing using a service parameter in accordance with one or more implementations.

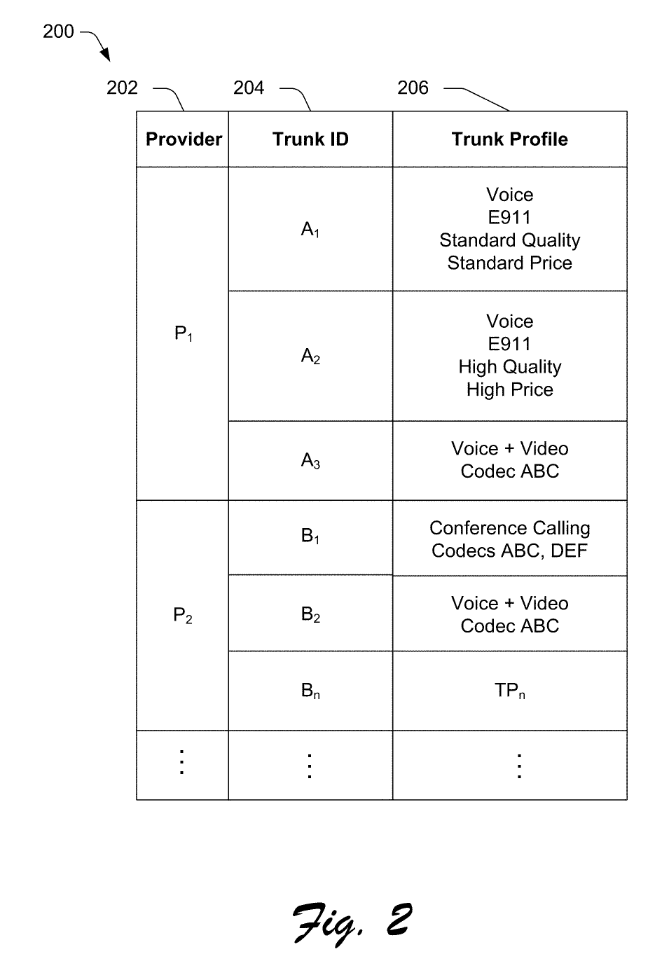

FIG. 2 depicts an example implementation of a provider table 200 that is stored as part of the trunk DB 126 in accordance with one or more implementations. Generally, the provider table 200 stores information for different trunks 124 maintained by different service providers 120.

The provider table 200 includes a provider 202 column, a trunk identifier (“ID”) 204 column, and a trunk profile 206 column. Provider 202 lists different instances of the service providers 120 that implement different instances of the trunks 124. The trunk ID 204 identifies different instances of the trunks 124 implemented by respective service providers 120 identified by the provider 204. Further, the trunk profile 206 includes specifications for different trunks 124 identified in the trunk ID column 204.

For instance, consider a provider P₁ that maintains trunks A₁, A₂, and A₃. A trunk profile 206 for the trunk A₁ indicates that the trunk A₁ is designated for voice media, emergency 911 (E911) service, standard media quality, and standard service pricing. Different trunks 124, for example, are characterized based on their relative usage pricing (e.g., cost/minute) and known or predicted media quality across the different trunks 124. Consider further a trunk A₂ implemented by the service provider P₁, which is designated for voice media, E911 service, high media quality, and high price. The trunk A₂, for instance, is characterized as having a higher media quality and higher usage price than the trunk A₁. Thus, if a standard media quality for a particular communication session is acceptable, the trunk A₁ may be selected to reduce a cost of the communication session. If a higher media quality for a communication session is desired, however, the trunk A₂ may be selected, but at a higher usage cost.

Consider further a trunk A₃ implemented by the provider P₁, which is designated for voice and video media and supports usage of a codec ABC for encoding and decoding of media data. Different trunks 124, for instance, can be characterized based on whether particular trunks 124 support a particular encoding technique.

The provider table 200 further lists a provider P₂ that implements trunks B₁, B₂, B₃, with respective trunk profiles indicated in the trunk profiles 206. The trunks B₁ . . . B₃, are each designed as supporting a particular set of capabilities as identified by their respective entries in the trunk profile 206.

Thus, the provider table 200 can be leveraged to track trunks maintained by different service providers, and service parameters supported by the different trunks. The communication service 112 can utilize the provider table 200 to identify a suitable service provider 120 and/or trunk 124 to be used for routing a particular communication session, such as based on a service parameter requested for the communication session.

Generally, the provider table 200 can be populated in various ways. The service providers 120, for instance, can publish information about their respective trunks 124 to the communication service 112, and the communication service 112 can populate the provider table 200 with the information. Alternatively or additionally, the communication service 112 can query the service providers 120 for information about their respective trunks 124, and the service providers 120 can return responses that include the information.

While the trunks identified in the trunk ID column 204 are identified as discrete instances of trunks, it is to be appreciated that the respective trunk IDs are generally indicative of logic representations of groups of different physical trunks that meet the specifications indicated in the trunk profile column 206.

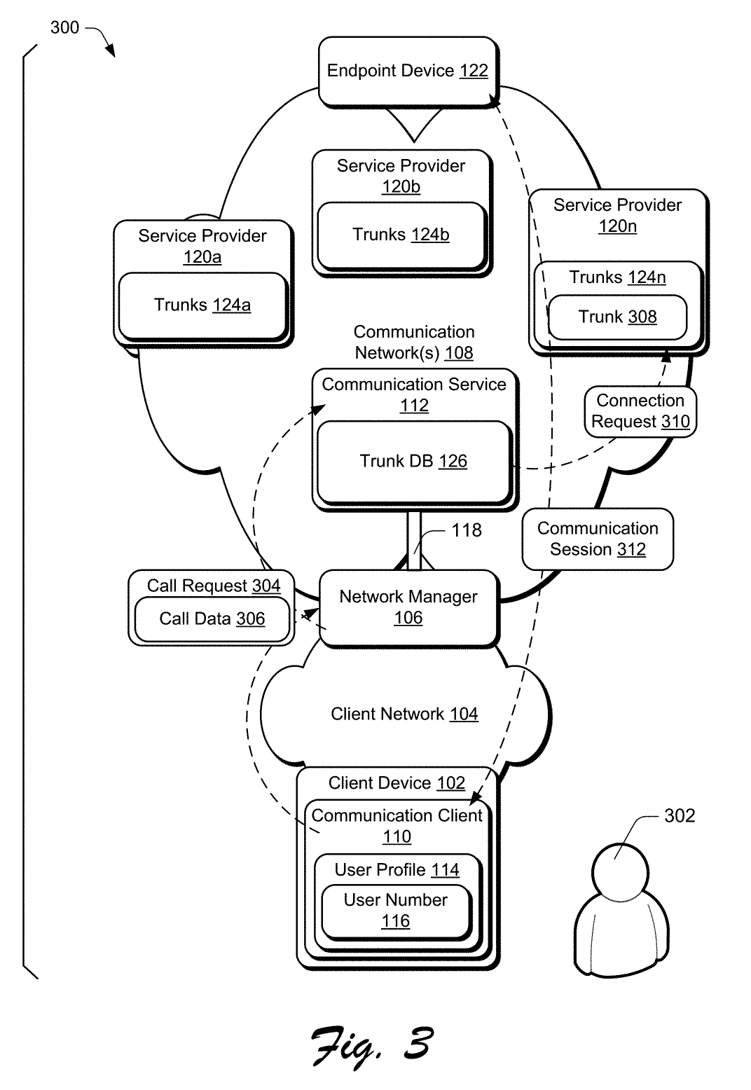

FIG. 3 depicts an example implementation scenario 300 for selecting a communication trunk for routing a communication session in accordance with one or more implementations. In the scenario 300, a user 302 of the client device 102 performs an action to initiate a communication session with an endpoint device 122a. The user 302, for instance, interacts with the communication client 110 to dial a phone number or select other identifying indicia for the endpoint device 122 using the client device 102.

Accordingly, the communication client 110 generates a call request 304 and transmits the call request 304 to the network manager 106. The call request 304 can be formatted in various ways, and in at least one implementation is generated as a SIP INVITE request. The call request 304 includes various information pertaining to establishing a communication session between the client device 102 and the endpoint device 122, such as the user number 116, a phone number for the endpoint device 122, a call identifier that can be used to track the communication session, and so forth. In this particular example, the call request 304 includes call profile data (“call data”) 306 that describes service parameters for the requested communication session. The call data 306, for instance, may be included as part of an extended field of a SIP header for the SIP INVITE. Examples of different service-related parameters that can be included in the call data 306 include:

Call Type—this parameter generally identifies a category of a call, such as a voice call, a conference call, a multimedia call (e.g., voice and video), an emergency services call, and so forth.

Media Type—this parameter indicates a type and/or types of media to be included in a call, such as voice, live video, content sharing, and so forth.

Encoding Type—this parameter indicates a type of media encoding (e.g., data compression and decompression) that is to be supported by a routing path for a communication session. Generally, encoding refers to audio encoding, video encoding, multimedia encoding, and combinations thereof. A particular call, for instance, may be encoded using a particular encoding scheme, and thus an encoding type parameter may specify that a routing path for the call support the encoding scheme.

Preferred Provider—this parameter identifies a preferred service provider 120 for connecting a call. In at least one implementation, if a preferred service provider 120 implements a trunk 124 that matches other call parameters in the call data 306, the trunk 124 is selected for connecting the call. If the preferred service provider 120 does not maintain such a trunk 124, however, a different service provider 120 that maintains a trunk 124 that matches the call parameters within the call data 306 may be selected, even though the different service provider 120 is not indicated as a preferred service provider.

Quality Parameter—this parameter indicates a quality-based request for a call. A quality parameter, for instance, may indicate that a standard call quality is acceptable for a call, or that a high call quality is requested for the call. Generally, call quality may be quantified in various ways, such as allowed packet errors and/or bit errors in a data stream of a communication session. Errors may be characterized in different ways, such as bit error rate (BER), packet error rate (PER), a number of dropped packets, and so forth.

In at least one implementation, a quality parameter corresponds to an error threshold. For instance, a standard call quality is associated with a first error threshold that corresponds to a requested maximum errors in a communication session. A high call quality, however, is associated with a second error threshold that is lower than the first error threshold. The second error threshold, for instance, specifies a lower maximum errors than the standard call quality.

Additionally or alternatively to consider errors in a communication session, a quality parameter may be based on user feedback regarding call quality across a communication path. User feedback, for example, may indicate a high call quality, acceptable call quality, or low call quality across a communication path. User feedback for call quality may be based on voice signal quality, video quality, connectivity quality and so forth.

Connectivity Parameter—this parameter indicates a connectivity requirement for a call. For instance, a particular call may be indicated as a “mandatory connect” call such that a routing path for the call is to be assigned regardless of usage cost or quality of the path. In at least one implementation, a mandatory connect call corresponds to an emergency services call and/or a call associated with some other urgent event.

Cost Parameter—this parameter indicates a cost constraint to be used for locating a routing path for a call. A cost parameter, for instance, can specify a maximum cost threshold for different cost constraints, such as for a low cost call, a standard cost call, or a high cost call. A low cost call, for instance, may specify that a routing path that does not exceed a first usage cost threshold is to be selected for completing the call. A standard cost call may be associated with a second cost threshold higher than the first cost threshold, and a high cost call may be associated with a third cost threshold higher than the second cost threshold.

Generally, a high quality routing path may be associated with a high usage cost. Thus, a call with a high cost parameter may be permitted to be routed across the high quality routing path, whereas a call with a standard cost parameter or a low cost parameter may not.

Legal Parameter—this parameter indicates a legal requirement for a call, such as based on laws and/or regulations in a particular jurisdiction in which at least a portion of a call occurs. A legal parameter, for instance, may indicate an allowed call behavior and/or a disallowed call behavior. One example of a legal parameter is lawful intercept, which requires that an entity with legal authority be able to access information pertaining to a call, such as call media, call signaling, and so forth. Other types of legal parameters indicate behaviors such as permitted call types across particular routing paths, permitted and impermissible routing behaviors, permitted and impermissible number usage (e.g., usage of a number with a geographic constraint outside of a permitted geographical area), and so forth.

These instances of the call data 306 are presented for purpose of example only, and it is to be appreciated that the call data 306 may include various instances and combinations of call-related information in accordance with techniques for trunk routing using a service parameter.

Continuing with the scenario 300, the network manager 106 forwards the call request 304 over the integrated trunk 118 to the communication service 112. The communication service 112 processes the call request 304 to obtain the call data 306, and uses the call data to identify a suitable trunk 124 to be used to attempt to connect a communication session based on the call request 304. The communication service 112, for instance, searches the trunk DB 126 using the call data 306 to identify a service provider 120 that implements a trunk 124 that is configured to handle a communication session described by the call data 306. For example, the communication service 112 compares the call data 306 to the provider table 200 to identify a trunk 124 with a trunk profile 206 that most closely correlates to a service parameter or set of service parameters included in the call data 306.

Consider, for instance, that the call data 306 includes a quality parameter specifying a high call data. Thus, a trunk 124 with a trunk profile 206 that indicates a high call quality can be selected. As another example, the call data 304 may specify a particular call type (e.g., voice, video, or multimedia), and thus the communication service 112 can select a trunk 124 with a trunk profile 206 that is designated as capable of handling the particular call type. These examples are presented for purpose of illustration only, and a variety of different call data 306 and call parameters may be considered in accordance with implementations for trunk routing using a service parameter described herein.

In at least one implementation, a trunk profile 206 with the most number of matching call parameters with the call data 306 is selected as a trunk 124 for completing the call request 304.

In the scenario 300, the communication service 112 compares the call data 306 to trunk profiles 206 for a service provider 120a which maintains trunks 124a, a service provider 120b which maintains trunks 124b, and a service provider 120n which maintains trunk 124n. Based on the comparison, the communication service 112 determines that a trunk 308 of the trunks 124n maintained by the service provider 120n has a trunk profile 206 that corresponds to the call data 306, and thus selects the trunk 308 for connecting a communication session for the call request 304.

Alternatively or additionally to identifying a specific trunk 124 that correlates to the call data 306, the communication service 112 may simply identify a particular service provider 120 that is capable of handling a communication session based on the call data 306, without identifying a discrete instance of a trunk 124. The communication service 112, for instance, can determine based on the trunk DB 126 that the service provider 120n is capable of connecting a communication

Accordingly, the communication service 112 communicates a connection request 310 to the service provider 120n for connecting a communication session based on the call request 304. In at least one implementation, the connection request 310 indicates that the trunk 308 is to be used for connecting a communication session. The connection request 310 also includes various information from the call data 306 to be used to connect the communication session. Examples of different call-related information from the call data 306 are described above.

The service provider 120n receives the connection request 310, and causes a communication session 312 to be connected between the client device 102 and the endpoint device 122 over the trunk 308. Generally, the communication session 312 is connected in compliance with one or more service parameters specified in the call data 306.

Alternatively to identifying a specific trunk 124n to be used for routing a communication session, the connection request may include the call data 306 and instructions for the service provider 120 to select an appropriate trunk 124n based on service parameters in the call data 306. Thus, the service provider 120n can use the call data 306 to select an appropriate trunk 124n (e.g., the trunk 308) without the communication service 112 identifying a specific trunk 124n to be used.

In an additional or alternative implementation, the communication service 112 can perform a negotiation process with a service provider 120 to determine whether the service provider 120 maintains a trunk that is capable of connecting a communication session based on the call request 304. Consider, for instance, the following scenario.

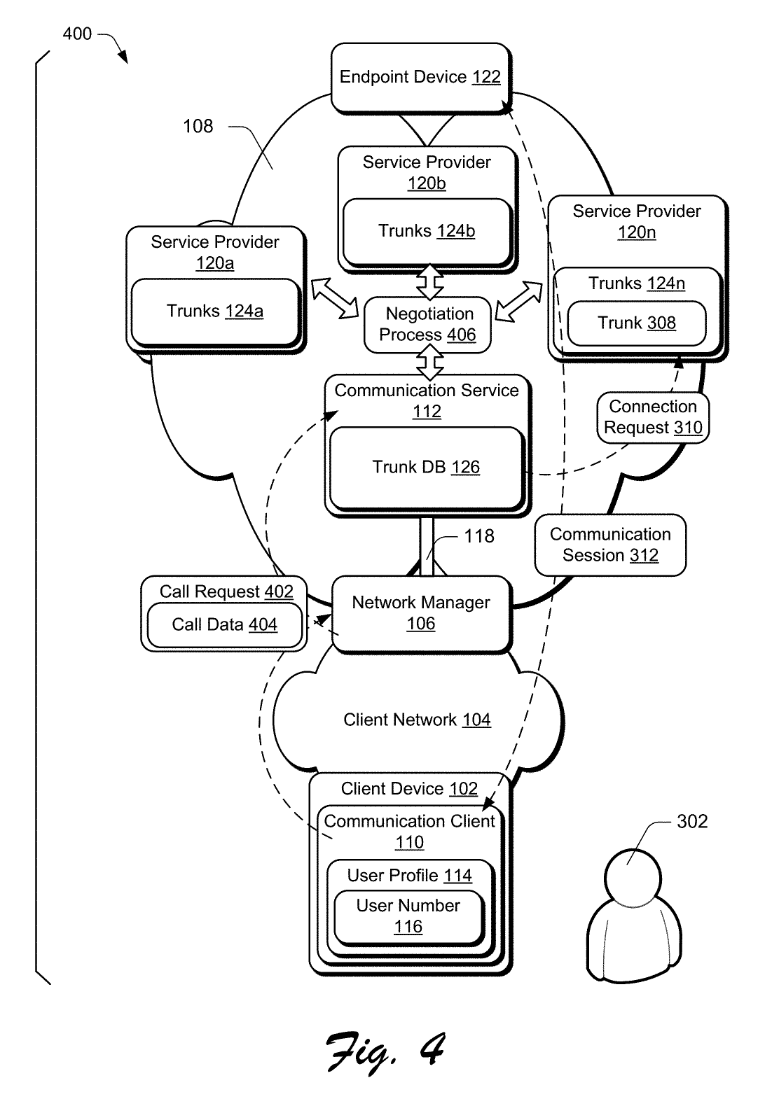

FIG. 4 depicts an example implementation scenario for dynamic negotiation of a trunk for routing a communication session in accordance with one or more implementations. The scenario 400, for instance, represents an alternative to or a variation of the scenario 300 discussed above.

The scenario 400 generally begins in a similar manner as the scenario 300, with the user 302 performing an action to initiate a communication session with the endpoint device 122a. Accordingly, a call request 402 is generated that includes call data 404. Examples of different information that can be included as part of the call request 402 and the call data 404 are described above.

The communication client 110 communicates the call request 402 to the network manager 106, which forwards the call request 402 over the integrated trunk 118 to the communication service 112. The communication service 112 processes the call request 402 to extract the call data 404, and engages in a negotiation process 406 to determine which of the service providers 120a-120n and/or trunks 124a-124n are to be used to connect a communication session based on the call request 402.

Generally, the negotiation process 406 involves interacting and exchanging data communication with one or more of the service providers 120a-120n to determine which of the service providers 120a-120n maintains a suitable trunk for connecting a communication session for the call request 402. For instance, as part of the negotiation process 406, the communication service 112 separately queries each of the service providers 120a-120n with the call data 404 to determine which of the service providers maintains a trunk 124 that is configured to handle a call with call parameters from the call data 404. Further to the negotiation process 406, the service providers 120a-120n each return a respective query response to the communication service 112 indicating whether (yes or no) each respective service provider has a trunk 124 that is configured to handle the communication session. Thus, the communication service 112 may select a service provider 120 that returns a response indicating that the service provider 120 is able to satisfy call parameters indicated by the call data 404. The communication service 112, for instance, may designate the first service provider 120 to return a “yes” query response as a service provider for connecting a communication session for the call request 402.

Alternatively or additionally, and as part of the negotiation process 406, query responses from the respective service providers 120a-120n indicate a relative strength of correspondence between a candidate trunk 124 for each of the service providers 120a-120n and the call data 404. For instance, consider that the call data includes three different service parameters to be considered for connecting a communication session. If a particular service provider 120 is able to satisfy all three service parameters (3/3), the service provider 120 may return a correspondence value of 1. If another service provider is only able to satisfy two of the three service parameters (2/3), the service provider 120 may return a correspondence value of 0.7. Thus, the communication service 112 may select a service provider 120 that returns a highest correspondence value as part of the negotiation process 406.

Further to the scenario 400 and based on the negotiation process 406, the communication service 112 selects the service provider 120n to connect the communication session. Accordingly, the communication service 112 communicates the connection request 310 to the service provider 120n, and the service provider 120n connects the communication session 312 over the trunk 308.

According to one or more implementations, the scenarios 300, 400 represent alternative ways for identifying a service provider 120 and/or a trunk 124 for connecting a communication session. In other implementations, however, the scenarios 300, 400 may be used in conjunction. For instance, the communication service 112 may identify a set of service providers 120 that maintain routing paths that are configured to connect a communication session, such as by comparing call data to the trunk DB 126 as described in the scenario 300. The communication service 112 may then perform a negotiation process with the identified set of service providers 120 to determine which individual service provider to select for connecting the call, such as described with reference to the scenario 400. Thus, in at least one implementation, selecting a trunk 124 for connecting a communication session may involve both a pre-selection process to identify a subset of service providers 120 that are candidates for connecting a communication session, along with a dynamic negotiation process for selecting a particular service provider 120 from among the candidate service providers 120 for connecting the communication session.

Having discussed some example implementation scenarios, consider now a discussion of some example procedures in accordance with one or more implementations.

The following discussion describes some example procedures for trunk routing using a service parameter in accordance with one or more implementations. The example procedures may be employed in the environment 100 of FIG. 1, the system 900 of FIG. 9, and/or any other suitable environment. The procedures, for instance, represent example ways of performing various aspects of the scenarios described above. In at least some implementations, the steps described for the various procedures can be implemented automatically and independent of user interaction. Further, various steps of the procedures may be performed at the client device 102, at the communication service 112, and/or via interaction between these entities.

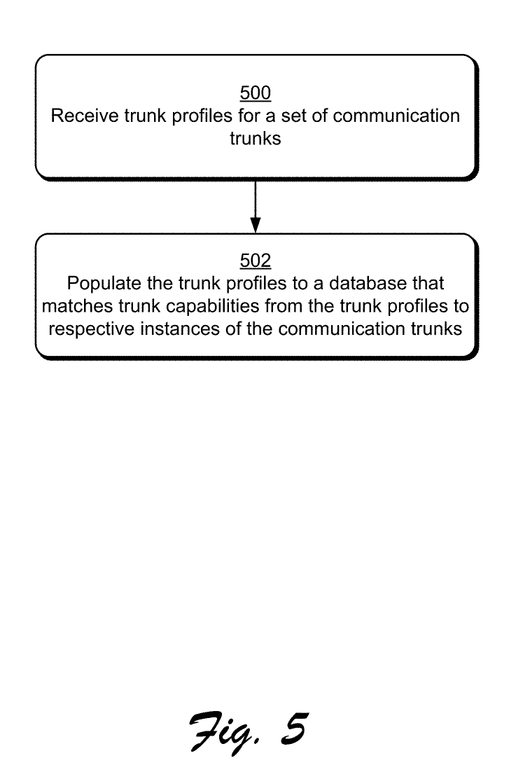

FIG. 5 is a flow diagram that describes steps in a method in accordance with one or more implementations. The method, for instance, describes an example way of generating a profile database for different communication trunks.

Step 500 receives trunk profiles for a set of communication trunks. For instance, the communication service 112 receives trunk capabilities for different communication trunks 124 from the service providers 120. In at least one implementation, the service providers 120 can push trunk profiles for their respective trunks 124 to the communication service. Alternatively or additionally, the communication service 112 can query the service providers 120 for their trunk profiles, and the service providers 120 can return trunk profiles for their respective trunks 124.

Step 502 populates the trunk profiles to a database that matches trunk capabilities from the trunk profiles to respective instances of the communication trunks. The communication service 112, for example, stores the trunk profiles as part of the trunk DB 126. As discussed above, the trunk profiles generally indicate capabilities for each of the trunks 124. In at least some implementations, the trunk profiles are correlated in the trunk DB 126 to service providers 120 that implement the respective trunks 124.

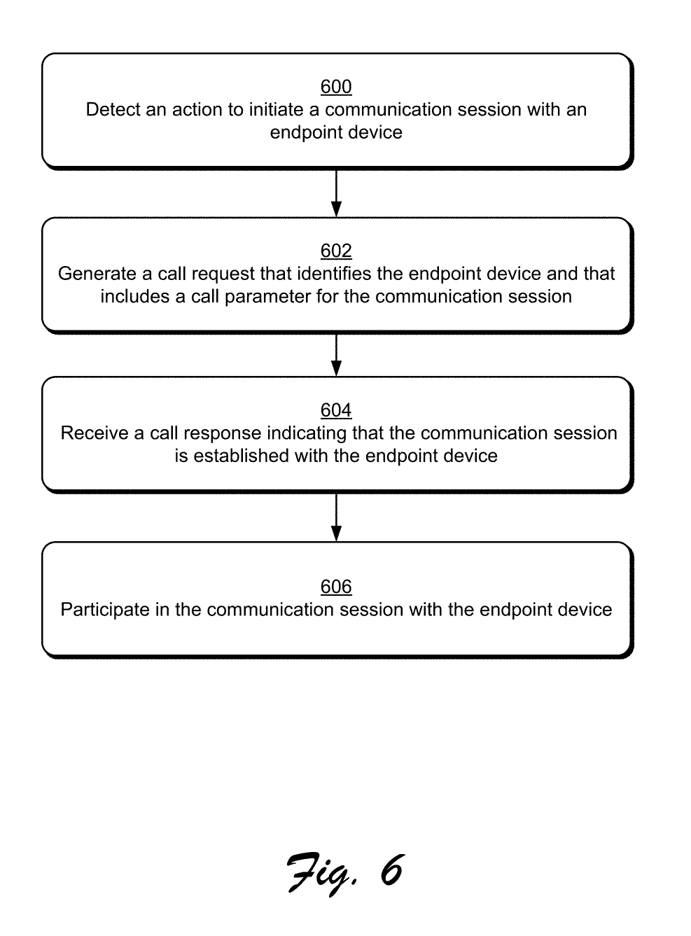

FIG. 6 is a flow diagram that describes steps in a method in accordance with one or more implementations. The method, for instance, describes an example way of establishing a communication session over a communication trunk. In at least one implementation, the method is performed by the communication client 110 on the client device 102.

Step 600 detects an action to initiate a communication session with an endpoint device. The communication client 110, for instance, detects user input to the client device 102 to initiate a communication session with an endpoint device 122. The user input may occur in various ways, such as a user dialing a phone number for the endpoint device 122, a user selecting a hyperlink that points to the endpoint device 122, voice input requesting that a call be established with the endpoint device 122, and so forth.

Step 602 generates a call request that identifies the endpoint device and that includes a call parameter for the communication session. The call request, for instance, includes an identifier for an endpoint device 122, such as a phone number, an Internet Protocol (IP) address, a contact name, and so forth. Generally, the call parameter corresponds to a trunk capability required for handling the communication session. In at least one implementation, the call parameter describes a service parameter that a trunk 124 is to support if the trunk is to be used for routing the communication session. As discussed above, the call request may be generated as a SIP-based request, such as an SIP INVITE request.

Step 604 receives a call response indicating that the communication session is established with the endpoint device. The communication client 110, for example, receives a response from the communication service 112 indicating that the call request is accepted and that a communication session is connected with an endpoint device 122. The call response may be implemented in various ways, such as a SIP response, e.g., an “OK” response indicating that the call request was successful in connecting the requested call. In at least one implementation, the call response identifies a trunk 124 over which the communication session is routed. The trunk, for instance, is selected according to techniques for trunk routing using a service parameter described herein.

Step 606 participates in the communication session with the endpoint device. The client device 102, for instance, exchanges communication media with the endpoint device, such as voice data, video data, content, and/or combinations thereof. According to one or more implementations, the communication session is performed on the client device 102 via interaction between the communication client 110 and the communication service 112.

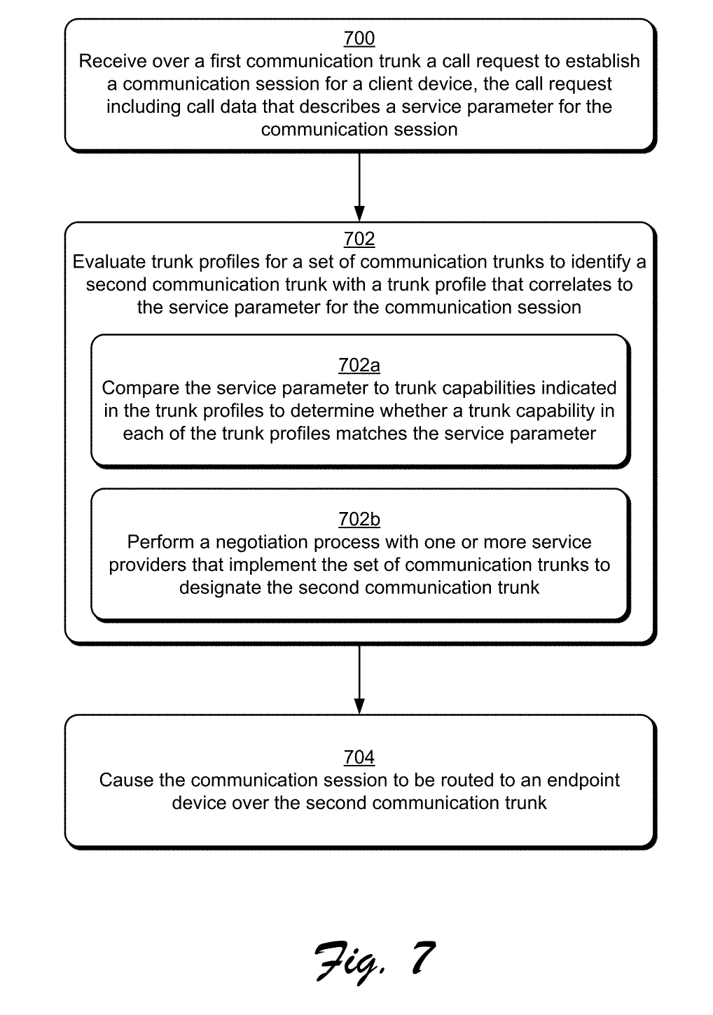

FIG. 7 is a flow diagram that describes steps in a method in accordance with one or more implementations. The method, for instance, describes an example way of causing a communication session to be routed over a communication trunk.

Step 700 receives over a first communication trunk a call request to establish a communication session for a client device, the call request including call data that describes a service parameter for the communication session. The communication service 112, for instance, receives the call request over the integrated trunk 118 from the communication client 110. In at least one implementation, the integrated trunk 118 is configured to route the call request from the client device 102 independent of the service requirement for the communication session. The integrated trunk 118, for instance, is configured to route call requests with different service requirements and without dependence on the type of service requirements.

The call request can include other information in addition to the service parameter, such as an identifier for a called endpoint device. Examples of different service parameters are detailed above. In at least one implementation, the call request is received as an SIP INVITE request.

Step 702 evaluates trunk profiles for a set of communication trunks to identify a second communication trunk with a trunk profile that correlates to the service parameter for the communication session. This step can be performed in various ways. For instance, step 702a compares the service parameter to trunk capabilities indicated in the trunk profiles to determine whether a trunk capability in each of the trunk profiles matches the service parameter. The communication service 112, for example, queries the trunk DB 126 using the call parameter to attempt to match the service parameter indicated by the call parameter to a capability of a trunk 124 and/or a service provider 120. A trunk 124 and/or a service provider 120 that matches the service parameter can be selected for routing the communication session.

In an example where the call request includes multiple service parameters, a trunk 124 and/or service provider 120 that matches the most service parameters (e.g., all of the service parameters) can be selected.

As another example was of performing the evaluating, step 702b performs a negotiation process with one or more service providers that implement the set of communication trunks to designate the second communication trunk. For instance, the evaluating step described above can include evaluating trunk profiles for a set of communication trunks to identify a set of communication trunks with a trunk profiles that correlate to the service parameter. The negotiating step then negotiates with the one or more service providers to designate the second communication trunk. One example of a suitable negotiation process is described below, as well as with reference to the scenario 400 described above with reference to FIG. 4.

According to various implementations, only one of the steps 702a, 702b may be performed to select a suitable communication trunk. Alternatively, the steps may be performed in conjunction with one another (e.g., sequentially) to select the suitable communication trunk.

Step 704 causes the communication session to be routed to an endpoint device over the second communication trunk. The communication service 112, for example, routes the call request to a service provider 120 that implements the second communication trunk. The service provider 120 then connects the communication session over the selected communication trunk with an endpoint device 122 identified in the call request.

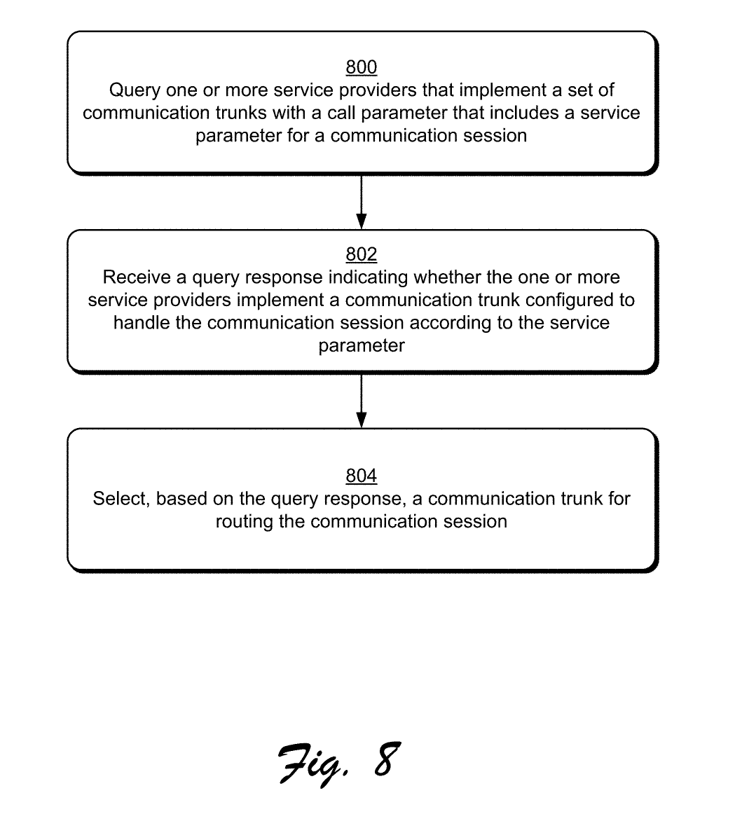

FIG. 8 is a flow diagram that describes steps in a method in accordance with one or more implementations. The method, for instance, describes an example way of negotiating with service providers to identify a suitable communication trunk for routing a communication session.

Step 800 queries one or more service providers that implement a set of communication trunks with a call parameter that includes a service parameter for a communication session. The communication service 112, for example, queries a set of service providers 120 with a call parameter received as part of a call request. The query, for example, request whether each of the service providers 120 maintains a trunk 124 that is capable of handling a communication session with a service parameter indicated by the call parameter. In at least one implementation, the queried set of service providers 120 are initially identified by querying the trunk DB 126 with the call parameter.

Step 802 receives a query response indicating whether the one or more service providers implement a communication trunk configured to handle the communication session according to the service parameter. For instance, the communication service 112 receives a query response from each queried service provider 120 indicating whether (yes or no) each service provider maintains a trunk capable of meeting the service parameter.

In at least one implementation, a query response from a service provider 120 can indicate a strength of correspondence between a trunk 124 maintained by the service provider 120, and the call parameter. For instance, if the call parameter includes multiple parameters, the query response can include a correspondence value indicating a number of the parameters that the trunk 124 is capable of supporting. See, for example, the discussion of the scenario 400 presented above.

Step 804 selects, based on the query response, a communication trunk for routing the communication session. The communication service 112, for instance, selects a communication trunk that is indicated in the query response as capable of meeting the service parameter.

As referenced above, multiple query responses may be received that each indicate a relative strength of correspondence between the call parameter (e.g., multiple call parameters) and respective call trunks. In such an implementation, the communication service 112 may select a trunk 124 with a highest correspondence value.

Accordingly, techniques for trunk routing using a service parameter described herein enable a suitable communication trunk (e.g., a SIP trunk) to be designated for handling a communication session.

Having discussed some example procedures, consider now a discussion of an example system and device in accordance with one or more implementations.

FIG. 9 illustrates an example system generally at 900 that includes an example computing device 902 that is representative of one or more computing systems and/or devices that may implement various techniques described herein. For example, the client device 102 and/or the communication service 112 discussed above can be embodied as the computing device 902. The computing device 902 may be, for example, a server of a service provider, a device associated with the client (e.g., a client device), an on-chip system, and/or any other suitable computing device or computing system.

The example computing device 902 as illustrated includes a processing system 904, one or more computer-readable media 906, and one or more Input/Output (I/O) Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 910 and computer-readable media 906 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules that are executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. For example, functionalities discussed with reference to the client device 102 and/or the communication service 112 may be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device implementation, implementation of functionality described herein may be distributed throughout the system 900. For example, the functionality may be implemented in part on the computing device 902 as well as via the platform 922 that abstracts the functionality of the cloud 920.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Techniques for trunk routing using a service parameter are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

In the discussions herein, various different implementations are described. It is to be appreciated and understood that each implementation described herein can be used on its own or in connection with one or more other implementations described herein. Further aspects of the techniques discussed herein relate to one or more of the following implementations.

A system for designating a communication trunk for routing a communication session, the system including: at least one processor; and one or more computer-readable storage media including instructions stored thereon that, responsive to execution by the at least one processor, cause the system perform operations including: receiving over a first communication trunk a call request to establish a communication session for a client device, the call request including call data that describes a service parameter for the communication session; evaluating trunk profiles for a set of communication trunks to identify a set of communication trunks with a trunk profiles that correlate to the service parameter; performing a negotiation process with one or more service providers that implement the set of communication trunks to designate a second communication trunk from the set of communication trunks for routing the communication session; and causing the communication session to be routed over the second communication trunk.

In addition to any of the above described systems, any one or combination of: wherein the first communication trunk is configured to route the call request from the client device independent of the service parameter for the communication session; wherein the service parameter identifies a call type for the communication session, the call type being one of a voice only call, a voice and video call, or a multimedia call; wherein the service parameter identifies a media quality parameter for the communication session; wherein the service parameter identifies an encoding type for the communication session; wherein the call request includes a Session Initiation Protocol (SIP) INVITE request, and the service parameter is included in the SIP INVITE request; wherein each of the trunk profiles identifies a trunk capability for a respective communication trunk of the set of communication trunks; wherein the set of communication trunks includes a set of different Session Initiation Protocol (SIP) trunks that are implemented by different service providers; wherein said evaluating includes comparing the service parameter to trunk capabilities indicated in the trunk profiles to determine whether a trunk capability in each of the trunk profiles matches the service parameter; wherein the negotiation process includes: querying one or more service providers that implement the set of communication trunks with the service parameter; and receiving a query response indicating whether the one or more service providers implement a communication trunk configured to handle the communication session according to the service parameter; wherein the negotiation process includes: querying one or more service providers that implement the set of communication trunks with the service parameter; and receiving a query response indicating a correspondence value for correlation between one or more communication trunks of the set of communication trunks, and the service parameter.

A computer-implemented method for designating a communication trunk for routing a communication session, the method including: receiving over a first communication trunk a call request to establish a communication session for a client device, the call request including call data that describes a service parameter for the communication session; evaluating trunk profiles for a set of communication trunks to identify a second communication trunk with a trunk profile that correlates to the service parameter; and causing the communication session to be routed to an endpoint device over the second communication trunk.

In addition to any of the above described methods, any one or combination of: wherein said evaluating includes determining based on the trunk profile that the second communication trunk is capable of meeting the service parameter; wherein said evaluating includes searching a database that includes the trunk profiles with the service parameter to identify the second communication trunk from the database; wherein said evaluating includes performing a negotiation process with a service provider that implements the second communication trunk to determine that the second communication trunk meets the service parameter; wherein said evaluating includes: querying a service provider that implements the second communication trunk with the service parameter; and receiving a query response indicating that the second communication trunk is capable of meeting the service parameter.

A computer-implemented method for designating a communication trunk for routing a communication session, the method including: receiving trunk profiles for a set of communication trunks; populating the trunk profiles to a database that matches trunk capabilities from the trunk profiles to respective instances of the communication trunks; receiving a call request to establish a communication session for a client device, the call request including call data that describes a service parameter for the communication session; evaluating the trunk profiles to identify a communication trunk from the set of communication trunks with a trunk profile that correlates to the service parameter; and causing the communication session to be routed over the communication trunk.

In addition to any of the above described methods, any one or combination of: wherein said populating includes correlating the communication trunks to respective service providers within the database; wherein the trunk profile for the communication trunk indicates one or more of a call type, a media type, or an encoding type that the communication trunk is configured to handle; wherein said evaluating includes performing a negotiation process with a service provider that implements the communication trunk to determine that the second communication trunk meets the service parameter.

What is claimed is:

1. A system comprising:
at least one processor; and
one or more computer-readable storage media including instructions stored thereon that, responsive to execution by the at least one processor, cause the system perform operations including:
receiving over a first communication trunk a call request to establish a communication session for a client device, the call request including call data that describes a service parameter for the communication session;
evaluating trunk profiles for a set of communication trunks to identify a set of communication trunks with a trunk profiles that correlate to the service parameter;
performing a negotiation process with one or more service providers that implement the set of communication trunks to designate a second communication trunk from the set of communication trunks for routing the communication session; and
causing the communication session to be routed over the second communication trunk.

2. A system as recited in claim 1, wherein the first communication trunk is configured to route the call request from the client device independent of the service parameter for the communication session.

3. A system as recited in claim 1, wherein the service parameter identifies a call type for the communication session, the call type being one of a voice only call, a voice and video call, or a multimedia call.

4. A system as recited in claim 1, wherein the service parameter identifies a media quality parameter for the communication session.

5. A system as recited in claim 1, wherein the service parameter identifies an encoding type for the communication session.

6. A system as recited in claim 1, wherein the call request comprises a Session Initiation Protocol (SIP) INVITE request, and the service parameter is included in the SIP INVITE request.

7. A system as recited in claim 1, wherein each of the trunk profiles identifies a trunk capability for a respective communication trunk of the set of communication trunks.

8. A system as recited in claim 1, wherein the set of communication trunks comprises a set of different Session Initiation Protocol (SIP) trunks that are implemented by different service providers.

9. A system as recited in claim 1, wherein said evaluating comprises comparing the service parameter to trunk capabilities indicated in the trunk profiles to determine whether a trunk capability in each of the trunk profiles matches the service parameter.

10. A system as recited in claim 1, wherein the negotiation process comprises:
querying one or more service providers that implement the set of communication trunks with the service parameter; and
receiving a query response indicating whether the one or more service providers implement a communication trunk configured to handle the communication session according to the service parameter.

11. A system as recited in claim 1, wherein the negotiation process comprises:
querying one or more service providers that implement the set of communication trunks with the service parameter; and
receiving a query response indicating a correspondence value for correlation between one or more communication trunks of the set of communication trunks, and the service parameter.

12. A computer-implemented method, comprising:
receiving over a first communication trunk a call request to establish a communication session for a client device, the call request including call data that describes a service parameter for the communication session;
evaluating trunk profiles for a set of communication trunks to identify a second communication trunk with a trunk profile that correlates to the service parameter; and
causing the communication session to be routed to an endpoint device over the second communication trunk.

13. A method as described in claim 12, wherein said evaluating comprises determining based on the trunk profile that the second communication trunk is capable of meeting the service parameter.

14. A method as described in claim 12, wherein said evaluating comprises searching a database that includes the trunk profiles with the service parameter to identify the second communication trunk from the database.

15. A method as described in claim 12, wherein said evaluating comprises performing a negotiation process with a service provider that implements the second communication trunk to determine that the second communication trunk meets the service parameter.

16. A method as described in claim 12, wherein said evaluating comprises:
querying a service provider that implements the second communication trunk with the service parameter; and
receiving a query response indicating that the second communication trunk is capable of meeting the service parameter.

17. A computer-implemented method, comprising:
receiving trunk profiles for a set of communication trunks;
populating the trunk profiles to a database that matches trunk capabilities from the trunk profiles to respective instances of the communication trunks;
receiving a call request to establish a communication session for a client device, the call request including call data that describes a service parameter for the communication session;
evaluating the trunk profiles to identify a communication trunk from the set of communication trunks with a trunk profile that correlates to the service parameter; and
causing the communication session to be routed over the communication trunk.

18. A method as described in claim 17, wherein said populating comprises correlating the communication trunks to respective service providers within the database.

19. A method as described in claim 17, wherein the trunk profile for the communication trunk indicates one or more of a call type, a media type, or an encoding type that the communication trunk is configured to handle.

20. A method as described in claim 17, wherein said evaluating comprises performing a negotiation process with a service provider that implements the communication trunk to determine that the second communication trunk meets the service parameter.
